(19) United States
(12) Patent Application Publication
(10) Pub. No.: US 2011/0221263 A1
(43) Pub. Date: Sep. 15, 2011

(54) ROTARY UNIT FOR BICYCLE HUB ASSEMBLY

(75) Inventor: PI-YUN CHIANG, TAICHUNG HSIEN (TW)

(73) Assignee: JOY INDUSTRIAL CO., LTD., TAICHUNG HSIEN (TW)

(21) Appl. No.: 12/720,909

(22) Filed: Mar. 10, 2010

(51) Int. Cl. B60B 27/02

(52) U.S. Cl. 301/110.5

(57) ABSTRACT

A hub assembly includes a hub and a driving tube is connected to one end of the hub, the driving tube includes a connection end and a sprocket portion located on two ends thereof. The connection portion is inserted into the hub and the sprocket portion has a reception hole defined in an end thereof. An axle extends through the hub and the driving tube. A rotary unit is located between the reception hole and the axle, and includes a tubular member which is mounted to the axle and includes a stop flange. At least one space is defined between the tubular member, the stop flange and an inner periphery of the reception hole. At least one self-lubricating bearing is located in the space and two sides of the self-lubricating bearing are well positioned by the stop flange and the locking unit.

### FIELD OF THE INVENTION

The present invention relates to a rotary unit, and more particularly, to a rotary unit cooperated with journal bearings to allow the hub assembly to be operated smoothly.

### BACKGROUND OF THE INVENTION

A conventional bicycle hub generally includes a driving tube connected to one end thereof and an axle extends through the hub and the driving tube. The driving tube includes a ratchet portion and a sprocket portion, and at least one bearing is located between the axle and the hub to le the hub together with the driving tube to rotate in one direction to drive the bicycle.

There are bearings used in the bicycle hub assembly to allow the hub to be rotated relative to the axle. The bearings used for hub assembly generally include two types which are the rolling contact bearings and the journal bearings. The rolling contact bearings mean that the two parts that have relative movement are in the form of rolling. The journal bearings include lubricant which provides a shear stress between the two parts that have relative movement. Most of the journal bearings are self-lubricating bearings.

A bicycle hub assembly known to applicant includes an axle which is connected to the bicycle frame and a hub is mounted to the axle. The hub includes ratchet grooves defined in one end thereof and a driving tube is connected to the ratchet grooves of the hub. The driving tube includes a sprocket portion to which the sprockets are connected. A self-lubricating bearing is located between the driving tube and the axle which extends through the self-lubricating bearing. The self-lubricating bearing includes an insertion which is inserted into the driving tube and a locking member is mounted to the axle and securely positions the driving tube and the self-lubricating bearing.

However, the thickness of the insertion of the self-lubricating bearing and the length of the sleeve have to be precisely manufactured, if the outer edges of the insertion and the sleeve are not located in flush with each other, the self-lubricating bearing will be locked and cannot rotate. The higher precision requirement increases the manufacturing cost of the hub assembly.

Another bicycle hub assembly known to applicant includes a hub mounted to the axle with multiple first bearings located therebetween. A driving tube is connected to one end of the hub by a clutch unit and at least one second bearing is located between the driving tube and the axle. Two restriction units are connected to two ends of the axle so as to restrict the axial movement of the hub relative to the axle. The restriction units include a ratchet ring which is threadedly connected to the hub, a collar located in the ratchet ring and connected to the driving tube, multiple pawls connected to exterior of the collar, and resilient members for keeping the pawls to be engaged with the ratchet ring. The axle includes a support portion extending radially from the axle and the support portion is located corresponding to the collar. A self-lubricating bear is mounted between the support portion and the collar, and includes inner surface which is mounted to the support portion. The self-lubricating bear further includes an outer surface which is engaged with an inner surface of the collar.

The self-lubricating bearing is located between the support portion and the collar, so that one end of the self-lubricating bearing is not well positioned, so that the self-lubricating bearing will loosen in the opened direction to affect the operation of the hub assembly.

The present invention intends to provide a hub assembly wherein the self-lubricating bearings are well positioned on both ends thereof to ensure smooth operation of the hub assembly.

### SUMMARY OF THE INVENTION

The present invention relates to a hub assembly and comprises a hub and a driving tube is connected to one end of the hub. The driving tube includes a connection end at a first end thereof and a sprocket portion is located on a second end of the driving tube, wherein the connection portion is inserted into the hub. The sprocket portion has a reception hole defined in an end thereof. An axle extends through the hub and the driving tube. A rotary unit is located between the reception hole and the axle, and includes a tubular member which is mounted to the axle and includes a stop flange extends radially from an outer surface thereof. At least one space is defined between the tubular member, the stop flange and an inner periphery of the reception hole. At least one self-lubricating bearing is located in the space.

The primary object of the present invention is to provide a hub assembly and the self-lubricating bearings are well positioned so as to avoid the self-lubricating bearing from movement in axial direction.

Another object of the present invention is to provide a hub assembly wherein the self-lubricating bearings are clamped between the stop flange of the tubular member, the reception hole of the driving tube and the locking unit. The arrangement simplifies the steps of assembly and reduces manufacturing cost.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the hub assembly of the present invention;

FIG. 2 is an exploded view to show the hub assembly the present invention;

FIG. 3 is a cross sectional view of the hub assembly the present invention;

FIG. 4 shows that the resilient member is an O-ring;

FIG. 5 is a cross sectional view of the hub assembly the present invention as shown in FIG. 4;

FIG. 6 shows that the resilient member is a C-shaped clip;

FIG. 7 is a cross sectional view of the hub assembly the present invention as shown in FIG. 6;

FIG. 8 shows that the two self-lubricating bearings include axial exterior grooves;

FIG. 9 is a cross sectional view of the hub assembly the present invention as shown in FIG. 8;

FIG. 10 shows that the two self-lubricating bearings include radial exterior grooves;

FIG. 11 is a cross sectional view of the hub assembly the present invention as shown in FIG. 10, and

FIG. 12 shows that the sprocket unit is composed of multiple sprockets.

### DETAILED DESCRIPTION OF THE PREFERRED EMBODIMENT

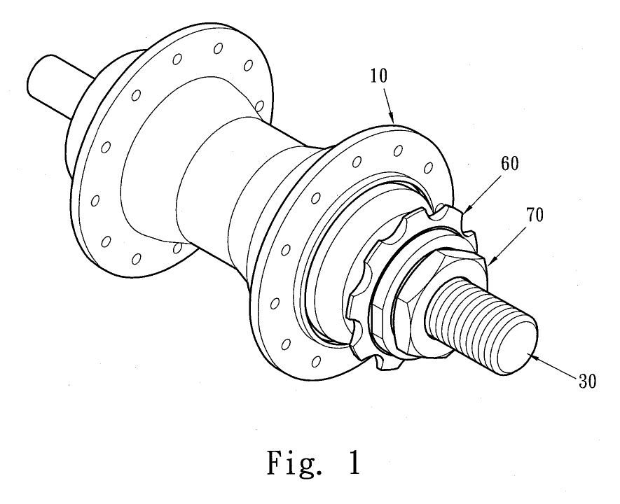

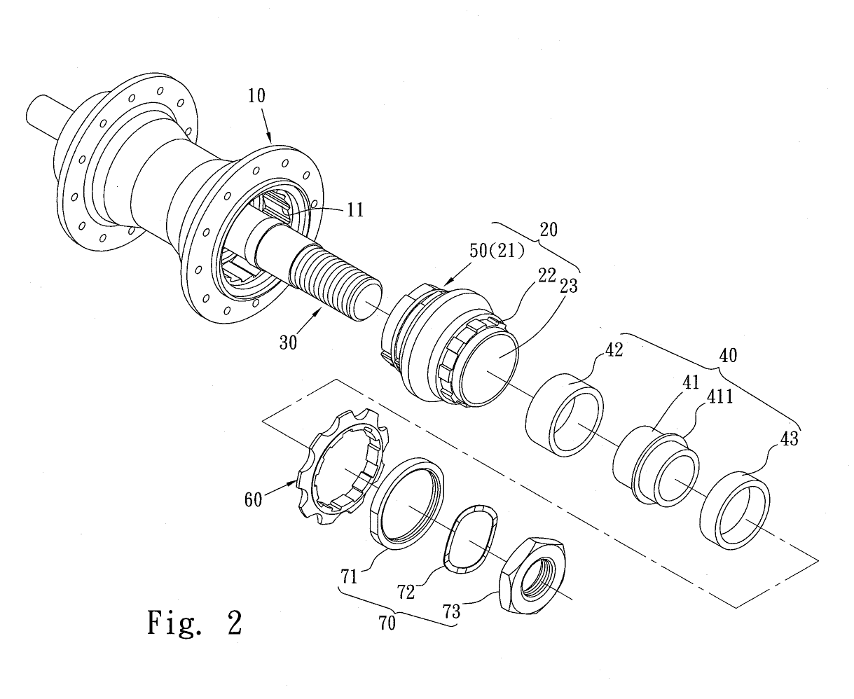

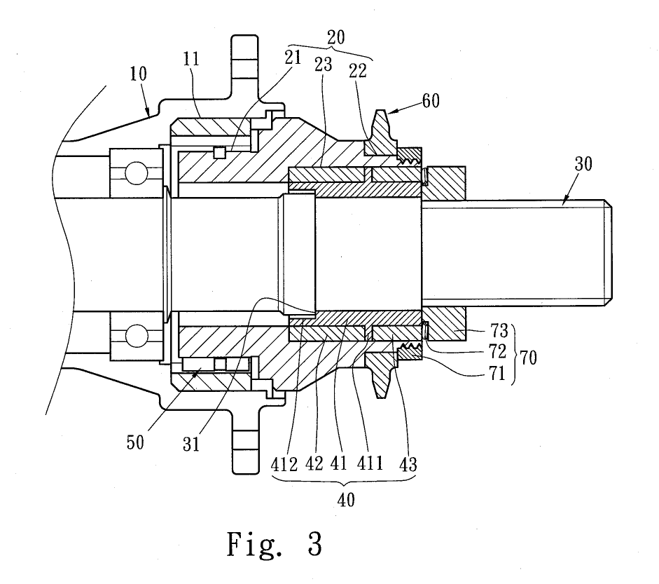

Referring to FIGS. 1 to 3, the hub assembly of the present invention comprises a hub 10 which is a hollow tube and multiple ratchet grooves 11 are defined axially in the first end of the hub 10. A driving tube 20 is connected to the first end of the hub 10. An axle 30 extends through the hub 10 and the driving tube 20. A rotary unit 40 is located between the driving tube 20 and the axle 30. A ratchet unit 50 is connected between the driving tube 20 and the hub 10. A sprocket unit 60 is mounted to the sprocket unit 50 and a locking unit 70 is connected to outside of the sprocket unit 60.

The driving tube 20 includes a connection end 21 at a first end thereof and a sprocket portion 22 located on a second end of the driving tube 20. The connection portion 21 is inserted into the hub 10 and the sprocket portion 22 has a reception hole 23 defined in an end thereof. The ratchet unit 50 is mounted to the connection end 21 of the driving tube 20 and co-rotated with the driving tube 20.

The rotary unit 40 is located between the reception hole 23 and the axle 30, and includes a tubular member 41 which is mounted to the axle 30 and includes a stop flange 411 extending radially from an outer surface thereof. Two spaces are defined between the tubular member 41, the stop flange 41 and an inner periphery of the reception hole 23. Two self-lubricating bearings 42, 43 are located in the two spaces respectively. The tubular member 41 includes a positioning shoulder 412 located in an inner periphery thereof and the axle includes a positioning flange 31 extending radially from an outer periphery thereof, the positioning flange 31 contacts the shoulder 412.

The sprocket unit 60 is mounted to the sprocket portion 22 of the driving tube 20 and co-rotated with the driving tube 20. In this embodiment, the sprocket unit 60 includes a single sprocket.

The locking unit 70 includes a locking ring 71, a resilient member 72 and a locking nut 73. The locking ring 71 has one side thereof contacting the sprocket unit 60. The resilient member 72 is a ring-shaped member and clamped between the locking nut 73 and the self-lubricating bearing 43. The locking nut 73 has one end extending through the resilient member 72 and contacting an end surface of the tubular member 41.

The two self-lubricating bearings 42, 43 are well positioned so that the rest of the parts are easily assembled and the rotation of the hub 10 is smooth. The two self-lubricating bearings 42, 43 do not move in axial direction.

When assembling, the axle 30 extends through the hub 10 and the self-lubricating bearing 42, the tubular member 41, the other self-lubricating bearing 43 are connected to the reception hole 23 in sequence. The two self-lubricating bearings 42, 43 are in contact with two sides of the stop flange 411. The ratchet unit 50 is then mounted to the connection end 21 and the positioning flange 31 contacts the shoulder 412. The sprocket unit 60 is then mounted to the sprocket portion 22 and the locking ring 71, the resilient member 72 and the locking nut 73 are mounted to the axle 30 one by one. The locking ring 71 is threadedly connected to the driving tube 20 and the locking nut 73 is threadedly connected to the axle 30. The locking ring 71 contacts the outside of the sprocket unit 60 and the resilient member 72 is clamped between the locking nut 73 and the self-lubricating bearing 43. The locking nut 73 extends through the resilient member 72 and contacts the end surface of the tubular member 41.

The two sides of self-lubricating bearing 42 are in contact with the stop flange 411 and the inner end of the reception hole 23 so that the self-lubricating bearing 42 is well positioned and does not move in axial direction.

The two sides of self-lubricating bearing 43 are in contact with the stop flange 411 and the resilient member 72 so that the self-lubricating bearing 43 is well positioned and does not move in axial direction.

The two self-lubricating bearings 42, 43 are precisely positioned so that other parts are easily assembled. The well positioned two self-lubricating bearings 42, 43 lead a smooth operation of the hub relative to the axle 30.

The positioning of the two self-lubricating bearings 42, 43 simplifies the steps of assembling of the hub assembly and reduces the manufacturing cost.

The cooperation between the positioning flange 31 and the shoulder 412 makes the assembling steps of the hub 10 and the axle 30 easy and convenient. By the arrangement, the driving tube 20 and the rotary unit 40 will not contact the sprocket unit 60 which is rotated with less friction.

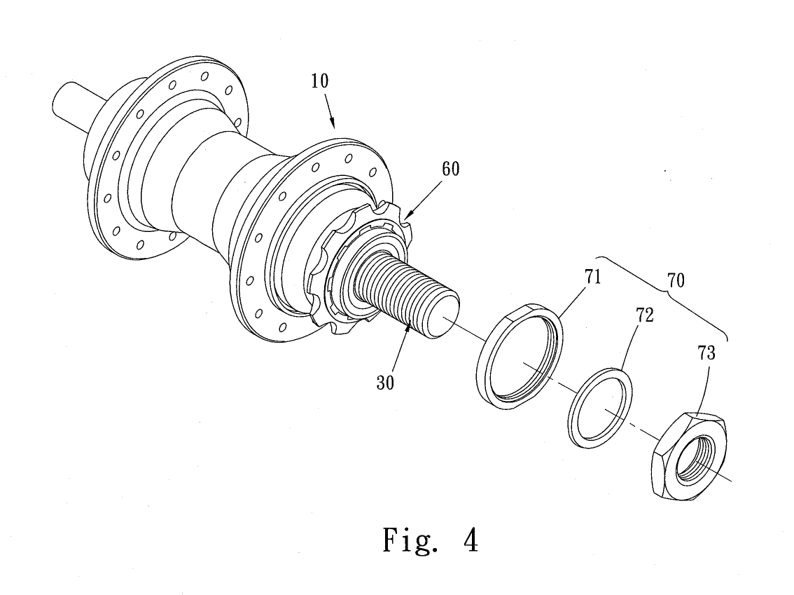

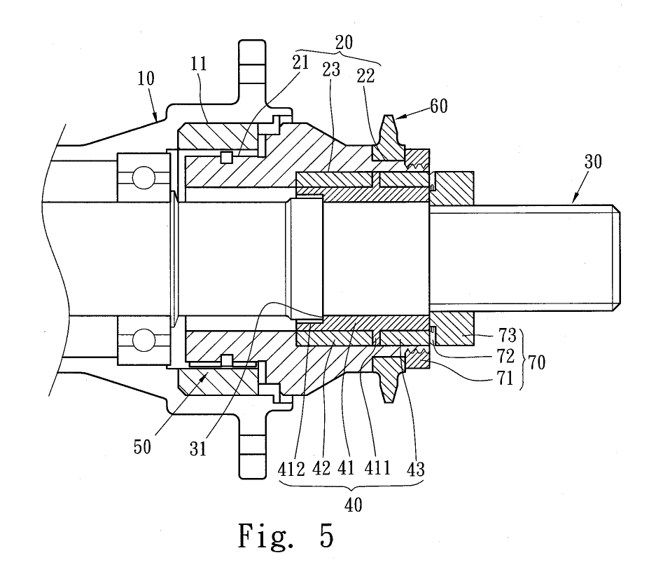

FIGS. 4 and 5 show that the resilient member 72 is made of plastic material and can be made as an O-ring.

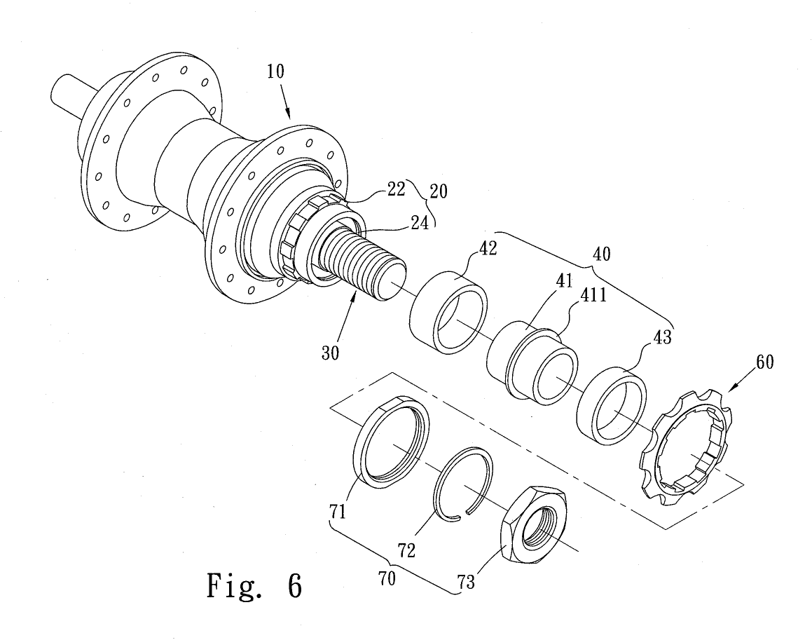

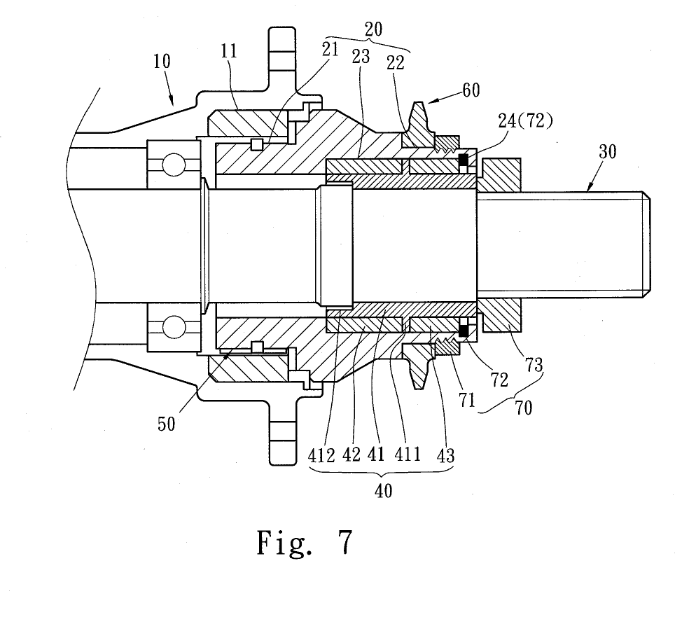

FIGS. 6 and 7 show that a positioning groove 24 is defined in the inner periphery of the reception hole 23 and the resilient member 72 is a C-shaped clip which is engaged with the positioning groove 24. The inside of the resilient member 72 contacts the outside of the self-lubricating bearing 43 which is prevented form movement outward.

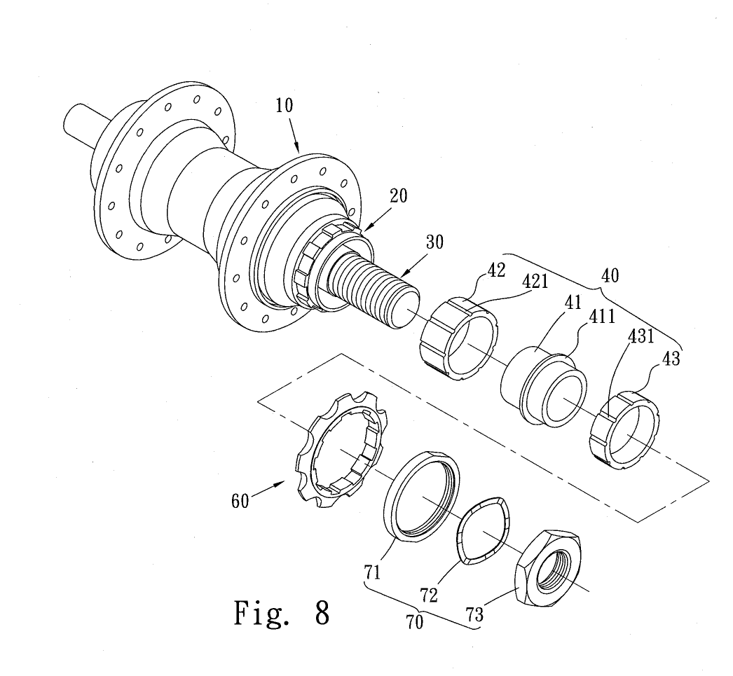

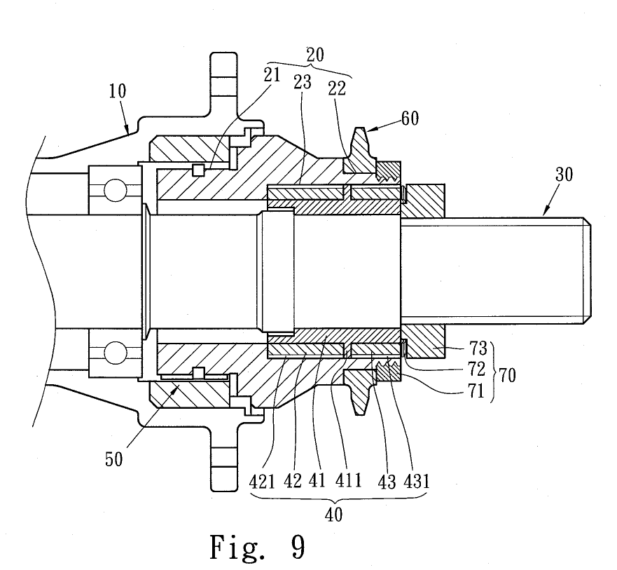

FIGS. 8 and 9 show that the self-lubricating bearings 42, 43 each include exterior grooves 421/431 defined axially in an outer surface thereof. The exterior grooves 421, 431 are parallel to the axes of the self-lubricating bearings 42, 43 and located at equal intervals. Lubricant is filled in the space defined between the exterior grooves 421, 431 and the inner periphery of the reception hole 23.

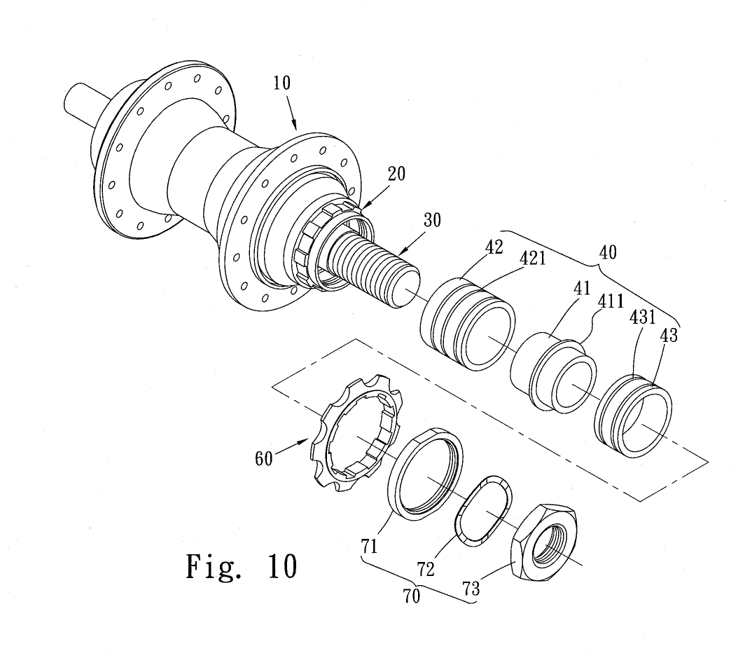

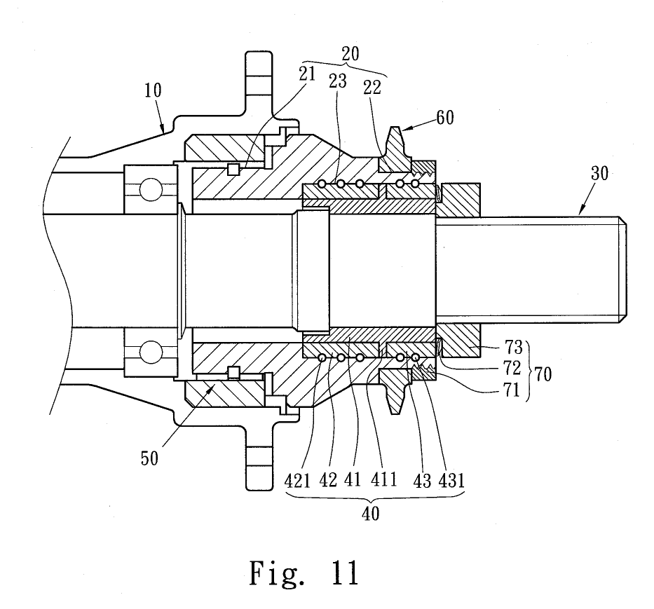

FIGS. 10 and 11 show that the self-lubricating bearing 42 includes three exterior grooves 421 defined radially in an outer surface thereof and the self-lubricating bearing 43 includes two exterior grooves 431 defined radially in an outer surface thereof. Lubricant is filled in the space defined between the exterior grooves 421, 431 and the inner periphery of the reception hole 23, or an O-ring is engaged within a space defined between the exterior grooves 421, 431 and the inner periphery of the reception hole 23.

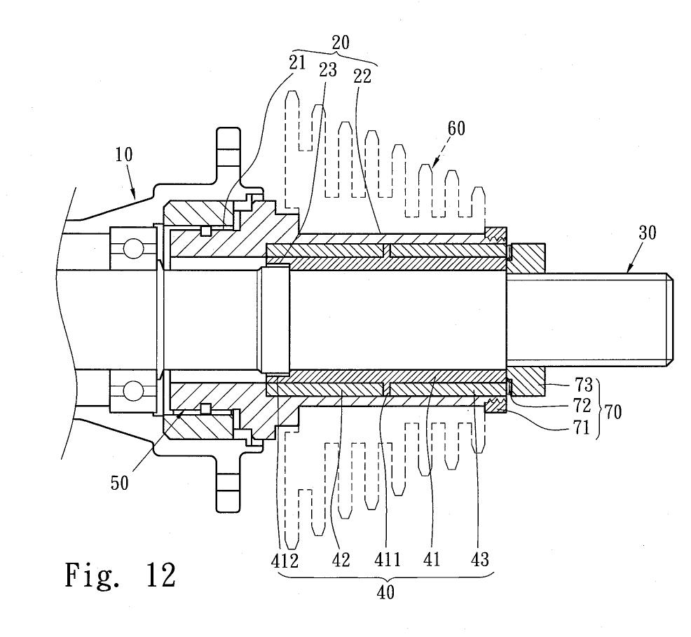

FIG. 12 shows that the sprocket unit 60 includes multiple sprockets which is mounted to the sprocket portion 22. This embodiment is used for the derailleur system of more than one speed option and a longer driving tube 20 and the longer sprocket portion 22 are needed.

While we have shown and described the embodiment in accordance with the present invention, it should be clear to those skilled in the art that further embodiments may be made without departing from the scope of the present invention.

What is claimed is:

1. A hub assembly comprising:
a hub;
a driving tube including a connection end at a first end thereof and a sprocket portion located on a second end of the driving tube, the connection portion inserted into the hub and the sprocket portion having a reception hole defined in an end thereof;
an axle extending through the hub and the driving tube, and
a rotary unit located between the reception hole and the axle, the rotary unit including a tubular member which is mounted to the axle and includes a stop flange extending radially from an outer surface thereof, at least one space defined between the tubular member, the stop flange and an inner periphery of the reception hole, at least one self-lubricating bearing located in the space.

2. The hub assembly as claimed in claim 1, wherein the tubular member includes a positioning shoulder located in an inner periphery thereof and the axle includes a positioning flange extending radially from an outer periphery thereof, the positioning flange contacts the shoulder.

3. The hub assembly as claimed in claim 1, wherein a ratchet unit is mounted to the connection end of the driving tube and co-rotated with the driving tube.

4. The hub assembly as claimed in claim 1, wherein a sprocket unit is mounted to the sprocket portion of the driving tube and co-rotated with the driving tube.

5. The hub assembly as claimed in claim 4, wherein the sprocket unit includes multiple sprockets.

6. The hub assembly as claimed in claim 4, wherein the sprocket unit includes a single sprocket.

7. The hub assembly as claimed in claim 4, wherein a locking unit includes a locking ring, a resilient member and a locking nut, the locking ring has one side thereof contacting the sprocket unit, the resilient member is clamped between the locking nut and the at least one self-lubricating bearing, the locking nut has one end extending through the resilient member and contacting the tubular member.

8. The hub assembly as claimed in claim 7, wherein the resilient member is a ring-shaped member.

9. The hub assembly as claimed in claim 7, wherein the resilient member is made of plastic material.

10. The hub assembly as claimed in claim 7, wherein the resilient member is an O-ring.

11. The hub assembly as claimed in claim 4, wherein a positioning groove is defined in the inner periphery of the reception hole, a locking unit includes a locking ring, a resilient member and a locking nut, the locking ring has one side thereof contacting the sprocket unit, the locking nut has one end extending through the resilient member and contacting the tubular member, the resilient member is engaged with the positioning groove and contacting the at least one self-lubricating bearing.

12. The hub assembly as claimed in claim 1, wherein the at least one self-lubricating bearing includes at least one exterior groove defined radially in an outer surface thereof and lubricant is filled in the at least one exterior groove.

13. The hub assembly as claimed in claim 1, wherein the at least one self-lubricating bearing includes at least one exterior groove defined radially in an outer surface thereof and an O-ring is engaged within a space defined between the at least one exterior groove and the inner periphery of the reception hole.

14. The hub assembly as claimed in claim 1, wherein the at least one self-lubricating bearing includes at least one exterior groove defined axially in an outer surface thereof and lubricant is filled in a space defined between the at least one exterior groove and the inner periphery of the reception hole.
